(19) United States
(12) Patent Application Publication
(10) Pub. No.: US 2019/0061581 A1
(43) Pub. Date: Feb. 28, 2019

(54) Seat Shell Formed by Additive Manufacturing

(71) Applicant: GM GLOBAL TECHNOLOGY OPERATIONS LLC, Detroit, MI (US)

(72) Inventors: Brennon L. WHITE, Novi, MI (US); Michael P. VAN DE VELDE, Shelby Township, MI (US); Shaun P. KAVANAGH, Clinton Township, MI (US); Scott D. THOMAS, Novi, MI (US)

(21) Appl. No.: 15/687,130

(22) Filed: Aug. 25, 2017

(51) Int. Cl. B60N 2/68; B60R 21/207; B60N 2/42

(52) U.S. Cl. CPC B60N 2/686; B60R 2021/2076; B60N 2/42; B60R 21/207

(57) ABSTRACT

A seat shell for use in a vehicle includes a support wall including a first surface and a second surface. The first surface is configured to support an occupant and the second surface is positioned opposite the first surface wherein the first surface and the second surface are separated by a thickness of the support wall. The seat shell further includes a conduit integrally formed in the support wall and positioned between the first and the second surface. The conduit is configured to transfer at least one of fluid, electricity and force from a first location in the support wall to a second location in the support wall.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a seat shell formed by additive manufacturing.

Additive manufacturing is the manufacture of components by adding material or adding elements rather than by removing material as is typically done in conventional manufacturing processes such as machining or milling. One process used in additive manufacturing is 3-dimensional (3D) printing. In a 3D printing process, multiple layers of material are added to one another to construct a 3-dimensional object. Additive manufacturing can be used in a wide range of industries, including the automotive industry.

Additive manufacturing can be applied to many systems in an automobile such as to the manufacture of a vehicle seat. A vehicle seat is a complex system that includes structural elements, comfort elements, occupant safety elements, climate control elements, electrical sensors and other elements. These various elements and other components are often manufactured separately from the vehicle seat and then connected to the seat support structure and/or routed through the support structure and the seat cushions.

### SUMMARY

An example seat shell for use in a vehicle in accordance with the present disclosure includes a support wall including a first surface and a second surface. The first surface is configured to support an occupant and the second surface is positioned opposite the first surface wherein the first surface and the second surface are separated by a thickness of the support wall. The seat shell further includes a conduit integrally formed in the support wall and positioned between the first and the second surface. The conduit is configured to transfer at least one of fluid, electricity and force from a first location in the support wall to a second location in the support wall.

In one aspect, the support wall is a seat bottom and the conduit is a plurality of channels that are configured to draw air into the plurality of channels and transfer the air to a climate control system of the vehicle.

In one aspect, the seat shell includes a vent located on the first surface of the support wall. The vent includes one or more openings to permit air to flow into the plurality of channels.

In one aspect, the conduit is a first wire embedded in the support wall between the first surface and the second surface. The first wire is configured to transmit a signal to or from a control module.

In one aspect, the seat shell further includes a second wire embedded in the support wall between the first surface and the second surface. The second wire is positioned in the support wall such that the second wire crosses the first wire in the support wall and the second wire is insulated from the first wire.

In one aspect, the seat shell includes an inflatable bladder in the support wall. The inflatable bladder includes an inlet port connected to an air source and a flexible membrane wall. The flexible membrane wall is adapted to move in response to a change in air pressure inside the inflatable bladder.

In one aspect, the flexible membrane wall of the inflatable bladder is integrally formed in the support wall.

In one aspect, the inflatable bladder is fluidly connected to the conduit at the inlet port and the conduit is a pressure line that is configured to transfer air from the air source to the inflatable bladder.

In one aspect, the seat shell includes a lever connected to the second surface of the support wall and to an adjustment mechanism. The adjustment mechanism is configured to adjust a position of the seat shell in the vehicle wherein the conduit is a pathway within the support wall that is configured to receive a cable therethrough and the cable is connected to the lever and to the adjustment mechanism such that a force applied to the lever is transferred by the cable through the conduit to the adjustment mechanism.

In one aspect, the seat shell includes a second support wall including a reinforcement embedded in the second support wall configured to stiffen the second support wall.

In one aspect, the second support wall defines a reinforcement cavity located within the second support wall. The reinforcement cavity is configured to receive a first portion of the reinforcement therein and the reinforcement is secured in position by forming the second support wall around a second portion of the reinforcement after the first portion of the reinforcement is positioned in the reinforcement cavity.

In one aspect, the seat shell includes a seat connector located on the support wall configured to connect the seat shell to the vehicle. The seat connector includes a fastener embedded in the support wall and projecting away from the second surface and a flexible bumper integrally attached to the second surface, wherein the seat connector is configured to dampen vibrations of the seat shell.

In one aspect, the seat shell includes an airbag housing integrally formed with and connected to the support wall. The airbag housing includes a deployment door with a tear seam, wherein the airbag housing is configured to receive an airbag module with a deployable airbag cushion and the tear seam of the deployment door is configured to break when the deployment door moves from a closed position to an open position to permit deployment of the airbag cushion.

In one aspect, the airbag housing includes an integrally formed attachment point for connecting a seat belt pretensioner to the seat shell.

In one aspect, the support wall includes an energy absorbing portion made of a first material with a first density and a rigid portion made of a second material with a second density wherein the first density is less than the second density.

In one aspect, the seat shell includes a rail channel integrally formed with and attached to the support wall and a rail bar integrally formed with and positioned inside the rail channel, wherein the rail bar is connected to the rail channel by a plurality of frangible elements and the plurality of frangible elements are configured to break to absorb energy when the seat shell is decelerated.

In one aspect, the seat shell includes a rail channel integrally formed with and attached to the support wall. The rail channel includes a finger projecting away from the rail channel and a rail bar integrally formed with and positioned inside the rail channel. The rail bar includes a flexible column wherein the finger is connected to the flexible column of the rail bar such that the flexible column flexes to absorb energy in response to a deceleration of the seat shell.

In one aspect, the seat shell is formed by a 3D printing process wherein the conduit is integrally formed into the seat shell during the printing process.

In one aspect, the seat shell includes a rotational element housing integrally formed with and attached to the support wall. The rotational element includes a flexible column. The seat shell also includes a rotational element integrally formed with and positioned inside the rotational element housing. The rotational element includes a finger wherein the finger is connected to the flexible column such that the flexible column flexes to absorb energy in response to a rotational movement of the seat shell.

In one aspect, the seat shell includes one or more trim attachments integrally formed with and positioned in the support wall. The trim attachments are configured to receive a mating trim component and secure the mating trim component relative to the support wall.

In one aspect, the support wall is contoured to include arm rests, shoulder rests and leg rests.

In one aspect, the seat shell includes a plurality of conduits integrally formed in the support wall and positioned between the first and the second surface. Each conduit of the plurality of conduits is configured to permit the transfer of at least one of fluid, electricity and force.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of one example seat shell in accordance with the present disclosure;

FIG. 2 is a sectional illustration of a portion of the seat shell of FIG. 1 showing an example conduit formed in the seat shell;

FIG. 3 is an illustration of one profile of an example conduit formed in the seat shell of FIG. 1;

FIG. 4 is an illustration of another profile of an example conduit formed in the seat shell of FIG. 1;

FIG. 5 is an illustration of another profile of an example conduit formed in the seat shell of FIG. 1;

FIG. 6 is an illustration of one example vent in accordance with the present disclosure;

FIG. 7 is a sectional illustration of one example movable louver in accordance with the present disclosure;

FIG. 8 is a sectional view of a portion of the example vent of FIG. 6;

FIG. 9 is another sectional view of the example vent of FIG. 6;

FIG. 10 is an illustration of another example vent in accordance with the present disclosure;

FIG. 11 is an illustration of another example vent in accordance with the present disclosure;

FIG. 12 is an illustration of another example vent in accordance with the present disclosure;

FIG. 13 is an illustration of an example embedded wire formed in the seat shell of FIG. 1;

FIG. 14 is an illustration of an example control module embedded in the seat shell of FIG. 1;

FIG. 15 is an illustration of an example cable routed through the seat shell of FIG. 1;

FIG. 16 is a sectional illustration of an example inflatable bladder formed in the seat shell of FIG. 1;

FIG. 17 is an illustration of an example seat shell showing a reinforcement embedded in the seat shell;

FIG. 18 is a sectional view of the example seat shell with the reinforcement of FIG. 17;

FIG. 19 is a side view of an example seat shell with a flexible bumper;

FIG. 20 is a sectional view of the flexible bumper of FIG. 19;

FIG. 21 is an illustration of another example seat shell with additional features in accordance with the present disclosure;

FIG. 22 is a sectional view of a portion of the seat shell of FIG. 21 showing an example airbag housing;

FIG. 23 is a partial exploded view of the seat shell of FIG. 21 showing an airbag module and a seat belt pretensioner connected to the seat shell;

FIG. 24 is a sectional view of a portion of the seat shell of FIG. 21 showing an example energy absorbing portion of the seat shell; and

FIG. 25 is an illustration of an example rail channel and rail bar of the seat shell of FIG. 21.

In the drawings, reference numbers may be reused to identify similar and/or identical elements.

### DETAILED DESCRIPTION

A seat shell in accordance with the present disclosure is formed using additive manufacturing and/or 3D printing. The seat shell is formed with various conduits formed within the walls of the seat shell for the transfer of fluids, gases, electricity or forces from one location in the seat shell to another location in the seat shell. The additive manufacturing or 3D printing process permits the seat shell to have an integrated structure rather than requiring auxiliary systems or components, such as climate control ducts, electrical wiring, seat position adjustment cables, seat adjustment structures, position sensors, inflatable bladders or airbags, to be subsequently connected to the seat structure.

The seat shell can include, for example, one or more ducts formed within the walls of the seat shell for conveying heated or cooled air to the seat shell or for returning air to the climate control system in the vehicle. The seat shell can also include one or more inflatable bladders formed within the walls of the seat shell that are connected to a source of pressurized air so that the inflatable bladders can be inflated or deflated to provide lumbar or other localized support to an occupant in the seat shell.

The seat shell can also include embedded wires that are formed or deposited within the walls of the seat shell. Various control modules located in the vehicle can transmit or receive electrical signals or electrical power through the embedded wires. The embedded wires can also be connected to vehicle sensors that are embedded in the seat shell.

The seat shell can also include one or more reinforcements that are inserted into the seat shell during the additive manufacturing process. The seat shell is formed around the reinforcement to embed the reinforcement into the walls of the seat shell. The seat shell can also have a fastener, such as a bolt or stud, embedded in the seat shell. Such an embedded fastener can be used to connect the seat shell to the body of the vehicle. The material at or around the fastener can be flexible to provide a flexible bumper at the point of attachment of the seat shell so that the flexible bumper absorbs vibrations.

The seat shell can include an airbag housing with a deployment door formed into the seat shell. The seat shell can include seat belt attachments and seat belt hardware mounting features. The seat shell can also include one or more areas made of an energy absorbing material. The seat shell can also include a rail channel and a rail bar formed into the seat shell. The rail channel and the rail bar can include energy absorbing material or frangible elements that connect the rail channel to the rail bar.

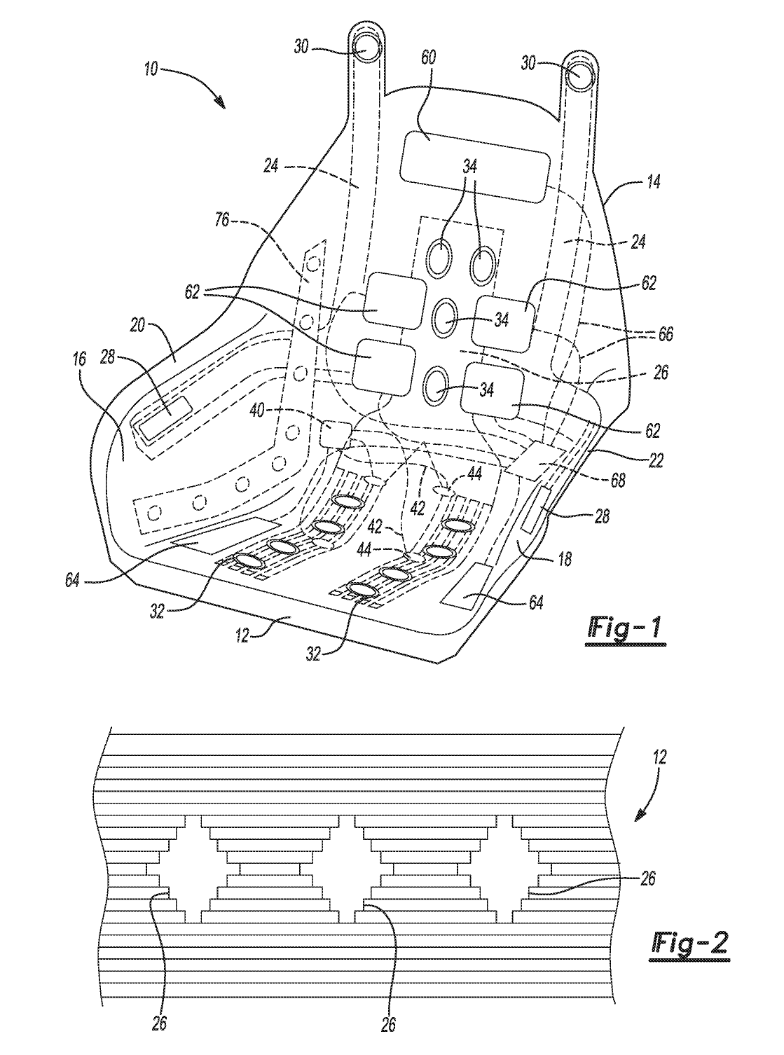

Referring now to FIG. 1, an example seat shell 10 includes one or more support walls such as a seat bottom 12, a seat back 14, a first side 16, a second side 18, a first armrest 20 and a second armrest 22. The seat shell 10 is formed in a contoured shape to support the back, sides, arms and legs of an occupant. The seat shell is formed using an additive manufacturing or a 3D printing process in which layer upon layer of material is deposited on top of each other or adjacent to each other to build the structure as will be described.

The 3D printing process can be combined with robotic arms and multi-axis fixtures to manipulate the seat shell during manufacturing or to pick and place various components that will be at least partially embedded into the seat shell. For example, a Stratasys Hydra additive manufacturing apparatus can be used to create one or more of the example seat shells described herein.

As shown in FIG. 1, the seat shell 10 includes supply ducts 24 and return ducts 26. The supply ducts 24 are defined within the walls of the seat shell 10 as cavities. In this manner, heated or cooled air can be transferred through the supply ducts 24. The return ducts 26 are also defined within the walls of the seat shell 10.

The supply ducts 24 extend downward from a top of the seat back 14 down through the seat back 14 and curve through the first side 16 and through the second side 18 as shown. A side vent 28 is located in the first side 16 under the first armrest 20 and another side vent 28 is located in the second side 18 under the second armrest 22. Two shoulder vents 30 are located toward the top of the seat back 14. In this configuration, heated or cooled air that is transmitted through the supply duct 24 can exit the supply ducts 24 through the side vents 28 and/or the shoulder vents 30. The heated or cooled air is supplied to the supply ducts 24 from a climate control system of the vehicle to an air supply port (not shown) located on the seat back 14 via a flexible or rigid interface.

The return ducts 26, in this example, are positioned on the seat back 14 and curve around and extend into the seat bottom 12. Bottom vents 32 are positioned in the seat bottom 12 and back vents 34 are positioned in the seat back 14. Air from the cabin of the vehicle and from the region surrounding an occupant that is sitting in the seat shell 10 is drawn into the return ducts 26 through the bottom vents 32 and/or the back vents 34. The return ducts 26 are connected with a flexible or rigid interface to an air return port (not shown) located on the seat bottom 12 or the seat back 14 that is then connected to the vehicle's climate control system.

This configuration of the supply ducts 24 and the return ducts 26 permits air to be supplied through the side vents 28 and the shoulder vents 30 in close proximity to an occupant seated in the seat shell 10. Air can also be drawn from the area in close proximity of the occupant through the bottom vents 32 and the back vents 34. The combination of the supply ducts 24 and the return ducts 26 creates a path of heated or cooled air. This path of heated or cooled air that is located in close proximity to the occupant is able to maintain a comfortable temperature for the occupant. In addition, since the supply ducts 24 and the return ducts 26 are formed within the seat shell 10 during the additive manufacturing process, the need to attach ducts to the seat shell 10 in subsequent operations is eliminated.

The supply ducts 24 and the return ducts 26 are formed in a suitable shape and size so as to provide the volumetric flow of air required to maintain comfortable temperatures for the occupant. The supply ducts 24 and the return ducts 26 are also formed in a suitable shape and size so as to maintain the structural integrity of the seat shell 10. In the example shown, the return ducts 26 located in the seat bottom 12 split from a single duct into four more narrow ducts that extend from the back of the seat bottom 12 toward the front of the seat bottom 12.

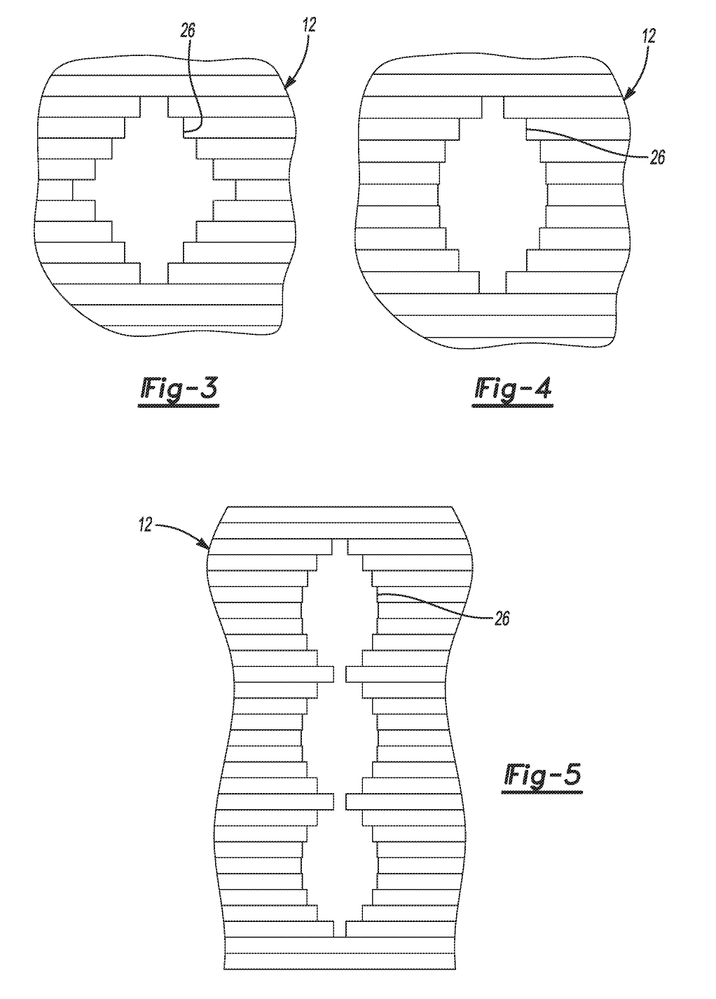

FIG. 2 shows a cross-section of one example configuration of return ducts 26 located in the seat bottom 12. As shown, the return ducts 26 have a diamond-shaped profile when viewed from the front. As shown in FIGS. 3-5, the return ducts 26 can have a diamond-shaped profile, a lens (or vesica piscis) shaped profile or a profile having a series of connected lens shapes.

When using a planar 3D printer, the shape of the vertical walls of a cavity, such as the return ducts 26, is limited. The shape is limited because as the 3D printer head deposits layer upon layer of material on top of one another, unsupported horizontal surfaces can collapse or sag. Therefore, the vertical walls of cavities in the seat shell 10 have the profiles previously described. Other profiles can also be used but the angle of the vertical wall from a vertical plane is generally less than 45 degrees.

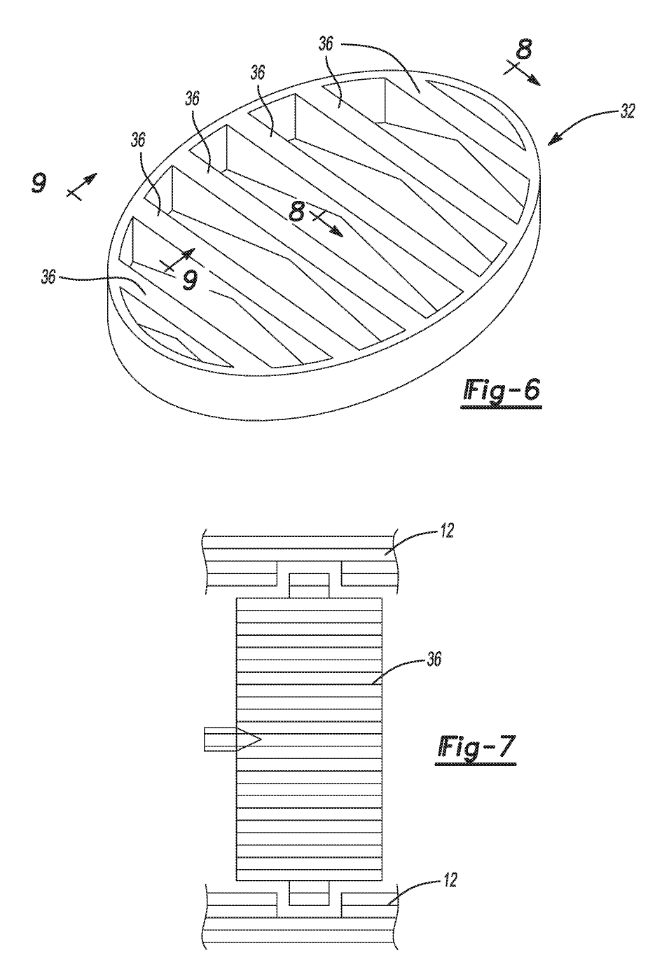

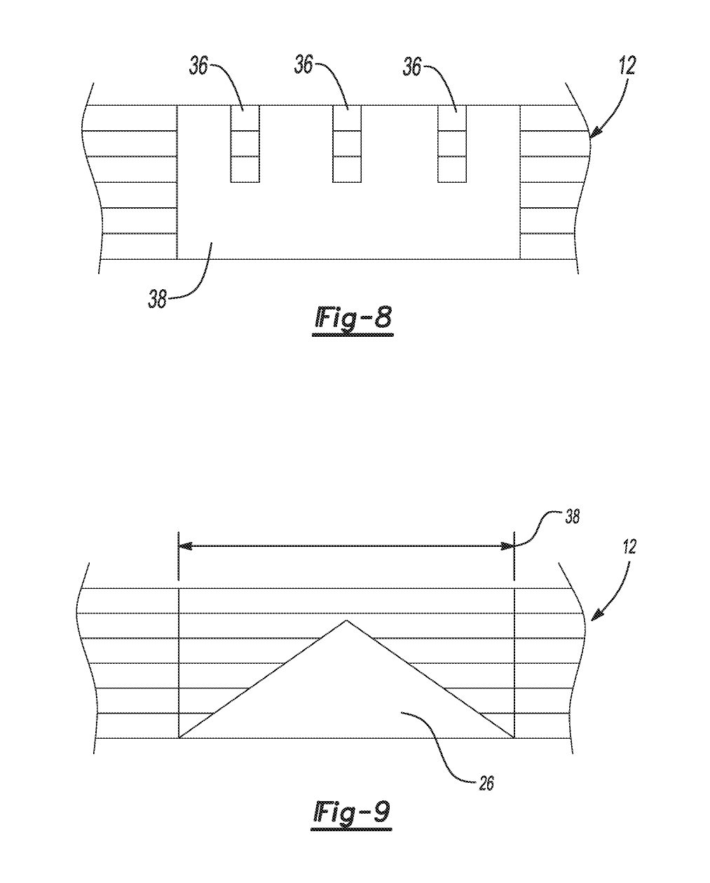

As shown in FIG. 1, the seat shell 10 includes the side vents 28, the shoulder vents 30, the bottom vents 32 and the back vents 34. The side vents 28, the shoulder vents 30, the bottom vents 32 and the back vents 34 each include one or more openings to permit the flow of air between the supply duct 24 or the return duct 26 and the cabin of the vehicle. As shown in FIG. 6, the side vents 28, the shoulder vents 30, the bottom vents 32 and the back vents 34 may have one or more louvers 36. The louvers 36 are planar members that extend across the opening 38. In one example, as shown in FIG. 7, the louvers 36 may be movably connected to the seat shell 12 at the edge of the opening 38 to permit an occupant to move the louvers 36 to direct the air flowing through the vent in a desired direction. In the movable louver example, the louver 36 includes a male portion at either end that extends into the adjacent side wall. The louvers 36 are formed into the side vents 28, the shoulder vents 30, the bottom vents 32 or the back vents 34 during the additive manufacturing process. As shown in FIGS. 8 and 9, the louvers 36 are spaced apart from one another across the opening 38 above the return duct 26.

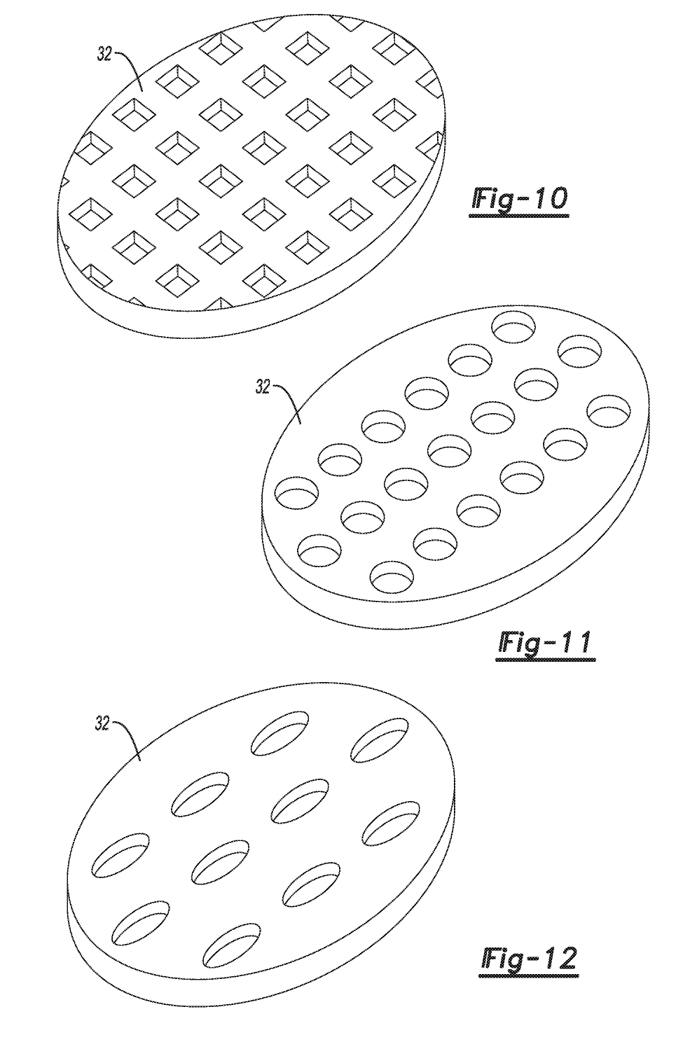

In other examples, the side vents 28, the shoulder vents 30, the bottom vents 32 and the back vents 34 may have other configurations other than the louvered configuration previously described. FIGS. 10-12 show other example configurations of the side vents 28, the shoulder vents 30, the bottom vents 32 and the back vents 34. As shown in FIG. 10, the vent can have a mesh configuration with a grid of individual rectangular openings. In FIG. 11, the vent has a series of round openings and in FIG. 12, the vent has a series of lens-shaped openings. As can be appreciated given the discussion above, the example configuration shown in FIG. 12 can be particularly useful in situations in which the vent is oriented in a vertical wall, such as on side vents 28. In this circumstance, circular or rectangular openings may not be possible given the limitations of some 3D printing equipment. Under these limitations, a vent profile such as that shown in FIG. 12 can be used.

In the example shown in FIG. 1, the side vents 28, the shoulder vents 30, the bottom vents 32 and the back vents 34 are formed into the support walls of the seat shell 10 during the additive manufacturing process. This structure eliminates the need for subsequent assembly of the side vents 28, the shoulder vents 30, the bottom vents 32 and the back vents 34 or for the subsequent cutting or milling of the seat shell 10 to add the side vents 28, the shoulder vents 30, the bottom vents 32 or the back vents 34. The previously described structure of seat shell 10 can also result in a seat shell 10 that is stiffer than other designs. This limits the need for additional shell reinforcements such as ribs or localized regions of increased thickness.

As shown in FIG. 1, the seat shell 10 includes a control module 40, wires 42 and sensors 44 that are positioned within the support walls of the seat shell 10. In this example, the control module 40, such as a seat control module, is positioned in the seat back 14. The wires 42 extend from the control module 40 to the sensors 44 within the seat back 14 and the seat bottom 12. As can be appreciated, in other examples, other control modules and other sensors, switches, power sources and other electrical equipment can be connected by other wires that extend through other support walls of the seat shell 10.

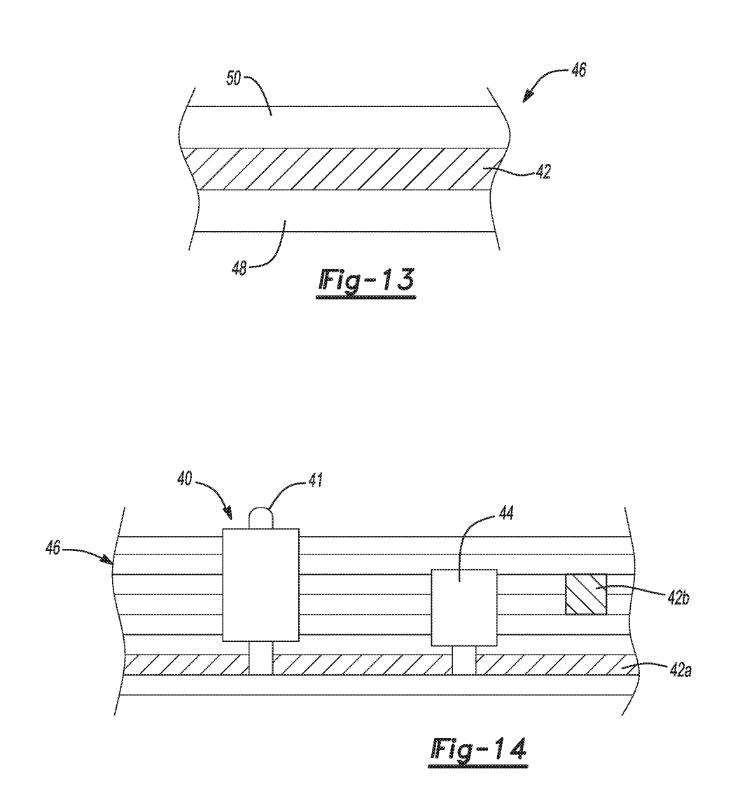

As illustrated in FIG. 13, the wire 42 is positioned within a support wall 46 of the seat shell 10. The wire 42 is embedded in the support wall 46 of the seat shell 10 during the additive manufacturing process. The wire 42 can be embedded in the support wall 46 using a technique in which a metal wire is inserted into the support wall 46 using a heated or vibrating disc or application tip in a manner known to one of ordinary skill in the art. The wire 42 can also be printed using a 3D printer with a metallic ink or metallic powder onto a first layer 48 in the support wall 46. A second layer 50 is printed over the printed wire 42. In this example, the first layer 48 and the second layer 50 are printed using an insulating material such as a suitable insulating plastic. The first layer 48 and the second layer 50 act as the insulator around the wire 42.

As shown in FIG. 14, a sensor 44 and a control module 40 are embedded in the support wall 46 in electrical connection with the wire 42a. In this example, the wire 42a, the sensor 44 and the control module 40 are embedded within the support wall 46 during the additive manufacturing process. During manufacture, the wire 42a is printed into the support wall 46. The sensor 44 and the control module 40 are picked and placed by a robotic arm so that their terminals are in contact with the wire 42a. The support wall 46 is then formed around the wire 42a and the sensor 44 to embed the wire 42a and the sensor 44 in the support wall 46.

The control module 40 can include a button 41 that projects outward from the control module 40 above the surface of the support wall 46. An occupant can access the button 41 to actuate or otherwise control the control module 40. As can be appreciated, the control module 40 can also, or alternatively, include other hand-operated control features such as a suitable lever, knob, tab, dial, touchscreen or other input device that can be used an occupant to control various elements of the interior environment of the vehicle such as temperature or seat position. After receiving an input from an occupant through the button 41 or other input device, the control module 40 can send a signal through the wire 42a to other receiving devices such as other modules, sensors, control systems or the like.

As can be appreciated, the wires 42 can be embedded in various locations and in various configurations throughout the seat shell 10. As shown in FIG. 1, the wires 42 can cross over one another as they extend through the seat shell 10. The wires 42 are insulated from one another, if desired, by layers of the material that form the support walls of the seat shell 10. As shown in FIG. 14, wire 42a extends transversely across the support wall 46. The wire 42b extends in a direction perpendicular direction to the wire 42a. The wires 42a and 42b are separated by a portion of the support wall 46 such that they are insulated from one another. In this manner the wires 42 can cross one another within the support walls 46 of the seat shell 10 while being insulated from one another.

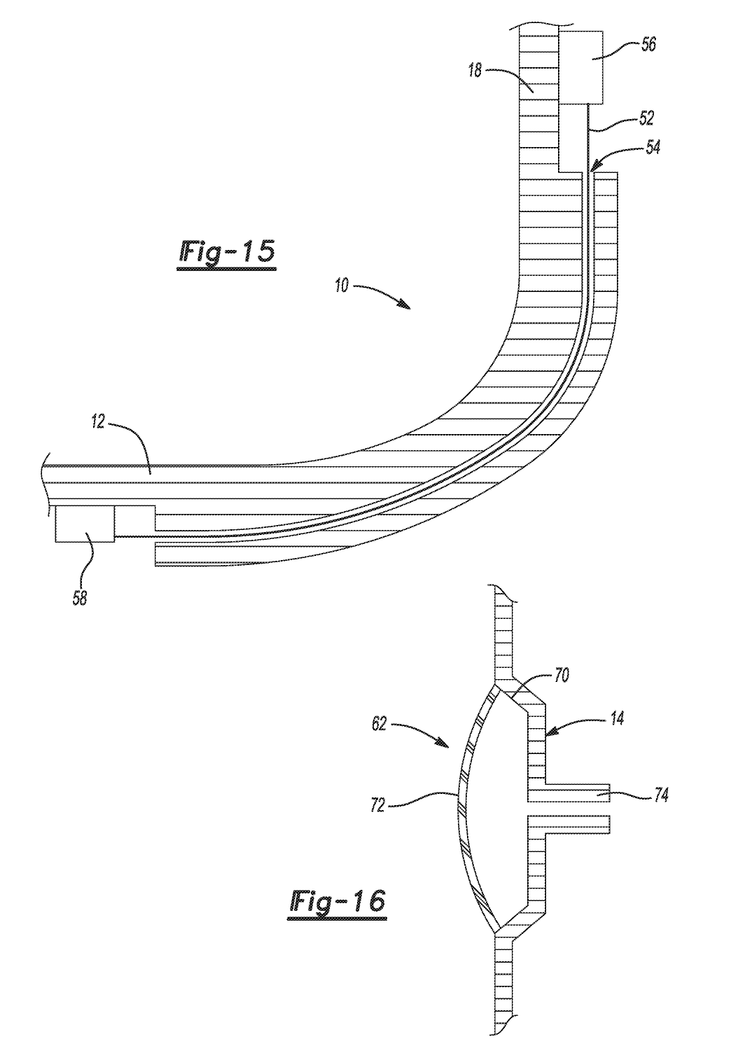

FIG. 15 shows a portion of the seat shell 10 in which a cable 52 is routed through a pathway 54 that is defined within the second side 18 and the seat bottom 12 of the seat shell 10. The cable 52 is connected to a first adjustment mechanism 56 at the second side 18. The cable 52 extends downward from the first adjustment mechanism 56 into the pathway 54. The pathway 54 extends through the second side 18 and curves around through the seat bottom 12. The cable exits the pathway 54 on the seat bottom 12 and is connected to a second adjustment mechanism 58.

The first adjustment mechanism 56 can be any suitable lever, knob, tab, button or other device that is manipulated by an occupant of the vehicle. One example of the first adjustment mechanism 56 is a lever used to adjust the position of the seat shell 10 in the vehicle. The second adjustment mechanism 58 can be any suitable complimentary device that interacts with the first adjustment mechanism 56 to cause an action in the vehicle. One example of the second adjustment mechanism 58 is a latch that secures the seat shell to a track in the vehicle. As can be appreciated, in this example, the occupant pulls (or otherwise manipulates) the lever on the first adjustment mechanism 56 whereby the force applied to the lever is conveyed via the cable 52 through the pathway 54 to the second adjustment mechanism 58. The force conveyed by the cable 52 causes the latch to release at the second adjustment mechanism 58 to permit the occupant to change the position of the seat shell 10 in the vehicle.

Cables such as Bowden cables are conventionally used to accomplish the transfer of force between adjustment mechanisms such as the one previously described. In such conventional systems, the Bowden cable includes a sheath of material that surrounds the cable. In the example shown, the external sheath of the conventional Bowden cable is eliminated. The pathway 54 that is formed within the walls of the seat shell 10 operates to convey the force applied at the first adjustment mechanism 56 to the second adjustment mechanism 58 as previously described.

As shown in this example, the pathway 54 extends within the seat shell 10 between the second side 18 and the seat bottom 12. In other examples, the pathway 54 can have other routes and can extend between other locations through the seat shell 10. In addition, the first adjustment mechanism 56 and/or the second adjustment mechanism 58 can operate other mechanisms such as seat reclining mechanisms, fuel door release mechanisms, trunk release mechanisms, hood release mechanisms, tray table release mechanisms, storage compartment lid release mechanisms, storage bin movement mechanisms, deployable barriers, privacy screens and the like.

Referring back to FIG. 1, the seat shell 10 includes one or more inflatable bladders that can inflate and deflate within the seat shell 10. The seat shell 10 includes an upper back bladder 60, lower back bladders 62 and leg bladders 64. The upper back bladder 60, the lower back bladders 62 and the leg bladders 64 are formed into the seat shell 10 during the additive manufacturing process.

FIG. 16 illustrates an example lower back bladder 62. As shown, the seat back 14 of the seat shell 10 is formed to have a depression 70. A flexible membrane surface 72 is then printed over the depression 70 to create the lower back bladder 62. With this structure, the lower back bladder 62 has a cavity between the seat back 14 and the flexible membrane surface 72. The lower back bladder 62 also has an inlet port 74 formed in the seat back 14. The inlet port 74 projects rearward from the lower back bladder 62 in this example.

A pneumatic control line 66 can be connected to the inlet port 74 to supply pressurized air to the lower back bladder 62. The pneumatic control line 66 conveys pressurized air with varying pressures to the lower back bladder 62. As the pressure of the air inside of the lower back bladder 62 is increased, the flexible membrane surface 72 can extend outward away from the seat back 14. Conversely, as the pressure of air inside the lower back bladder 62 is decreased, the flexible membrane surface 72 can move back toward the seat back 14. In this manner, the lower back bladder 62 can be inflated and deflated to increase or decrease the support to the occupant's body as desired by the occupant.

As previously described, the lower back bladder 62 is formed during the additive manufacturing process by printing the lower back bladder in different materials. For example, the seat back 14 is printed using an acrylonitrile butadiene styrene (ABS) thermoplastic polymer substrate. The flexible membrane surface 72 is printed using a different material such as a thermoplastic urethane or a thermoplastic elastomer. The material of the seat back 14 is relatively rigid and the material of the flexible membrane surface 72 is relatively flexible. This type of structure permits the lower back bladder 62 to inflate and deflate as previously described.

Since the lower back bladder 62 is formed in the wall of the seat shell 10 as previously described, subsequent assembly of a separate bladder is eliminated. As can be appreciated, the upper back bladder 60 and/or the leg bladders 64 are similarly formed into the seat shell 10 with corresponding flexible membrane surfaces 72 that are formed during the additive manufacturing process.

As shown in FIG. 1, the upper back bladder 60, the lower back bladders 62 and the leg bladders 64 are connected to a pneumatic control module 68 by the pneumatic control lines 66. The pneumatic control lines 66 are conduits formed into the support walls of the seat shell 10 that transfer pressurized air to and from the upper back bladder 60, the lower back bladders 62 and the leg bladders 64. The pneumatic control lines 66 are formed into the support walls of the seat shell 10 during the additive manufacturing process and can have profiles as that previously described with respect to the supply ducts 24 and the return ducts 26.

The pneumatic control module 68 is embedded in the seat shell 10 during the additive manufacturing process. The pneumatic control module 68 is embedded in a similar manner as that described with respect to sensor 44. The pneumatic control module 68 distributes pressurized air to the bladders in the seat shell 10.

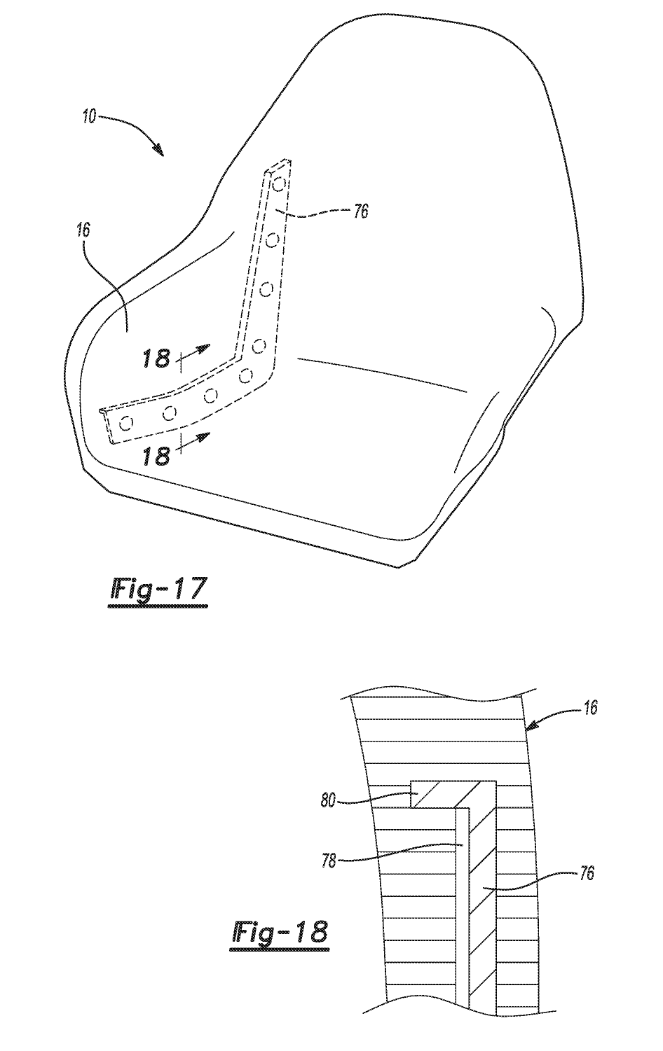

Referring now to FIG. 17, the example seat shell 10 includes a reinforcement 76 embedded in the first side 16. The reinforcement 76 is a rigid support member that is made of steel or other rigid material that stiffens the seat shell 10. In this example, the reinforcement 76 is L-shaped with an elongated horizontal portion that extends along a bottom of the first side 16 and an elongated vertical portion that extends away and upwards from the bottom of the first side 16 as shown. In other examples, the seat shell 10 can have additional reinforcements or reinforcements embedded in other locations to provide additional stiffness as required.

As shown in FIG. 18, the reinforcement 76 is embedded within the first side 16. During the additive manufacturing process, a reinforcement cavity 78 can be created in the first side 16. The reinforcement cavity 78 is defined within the first side 16 and is a void that is sized to accept the reinforcement 76. After the reinforcement cavity 78 has been created in the seat shell 10, the reinforcement 76 is inserted into the reinforcement cavity 78. When the reinforcement 76 is inserted by a robotic arm, for example, a top portion 80 of the reinforcement 76 is exposed above the reinforcement cavity 78. The first side 16 of the seat shell 10 is then formed by the 3D printing process around the top portion 80 of the reinforcement 76. In this manner, the reinforcement 76 is embedded within the seat shell 10. As can be appreciated, the reinforcement cavity 78 can be created in different sizes so that more or less than the top portion 80 of the reinforcement 76 can be exposed when the reinforcement 76 is inserted into the reinforcement cavity 78. Therefore, more or less than the top portion 80, shown in FIG. 18, can be surrounded by the first side 16 to embed the reinforcement 76 into the seat shell 10. Reinforcement 76 can be entirely embedded into the seat shell 10 or can be partially embedded into the seat shell 10.

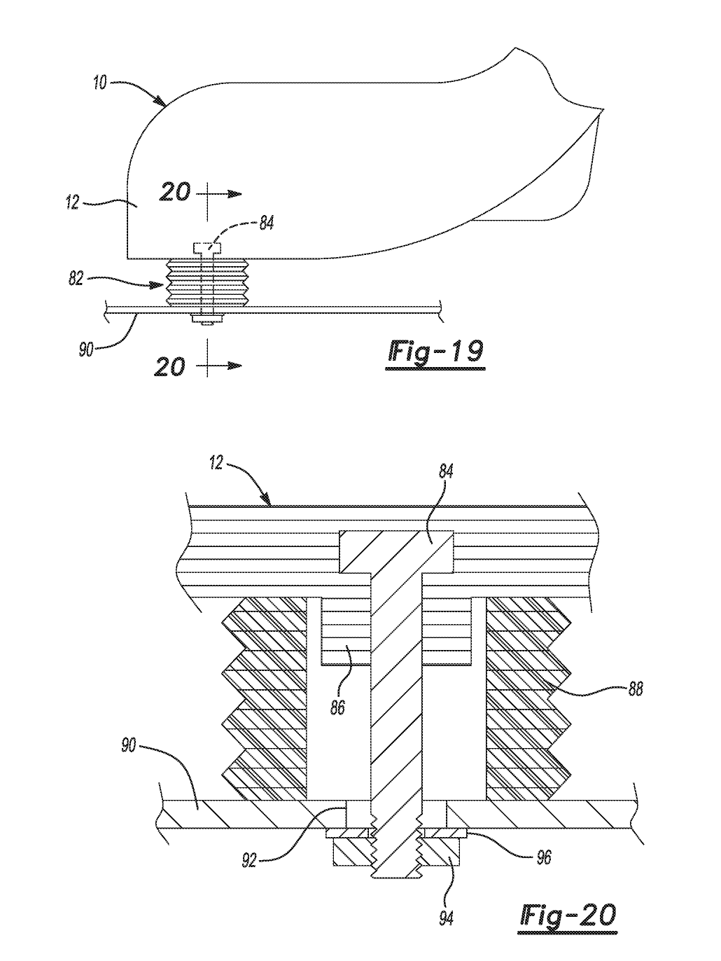

As shown in FIGS. 19 and 20, the seat shell 10, in this example, includes a seat connector 82. The seat connector 82 is located on the lower surface of the seat bottom 12. The seat connector 82 includes a stud 84, a boss 86, and a flexible bumper 88. The seat connector 82 is used to secure the seat shell 10 to a body panel 90 of the vehicle, such as a floorpan of the vehicle. In this example, the stud 84 inserted into an opening 92 in the body panel 90 and secured with a nut 94. A seal 96 can be inserted between the nut 94 and the body panel 90 to seal the opening 92 from the intrusion of water or other contaminants.

The seat connector 82 is formed during the additive manufacturing process. The stud 84, such as a suitable bolt or other fastener, is inserted into the seat bottom 12 during the 3D printing process. The remaining portion of the seat shell 10 is printed around the stud 84 to embed the stud 84 into the seat bottom 12. The boss 86 is a cylindrical formation that surrounds the stud 84 and projects away from the bottom of the surface of the seat bottom 12. The boss 86 provides additional stiffness to the embedded stud 84.

The bumper 88 is also formed into the seat shell 10 during the additive manufacturing process. The bumper 88 is printed into the seat shell 10. The bumper 88 is generally cylindrical in shape with an accordion-shaped outer profile as shown in FIG. 20. Other examples of the bumper 88 can have other profiles as well.

The bumper 88 is formed of a material that is flexible. In this example, the bumper 88 is formed of a thermoplastic elastomer such that it can deform in a direction parallel to the center axis of the stud 84. When the seat shell 10 vibrates or is subjected to accelerations in the vertical direction, the bumper 88 dampens the vibrations and reduces undesirable movement of the seat shell 10. The bumper 88 can be formed of other flexible materials as well.

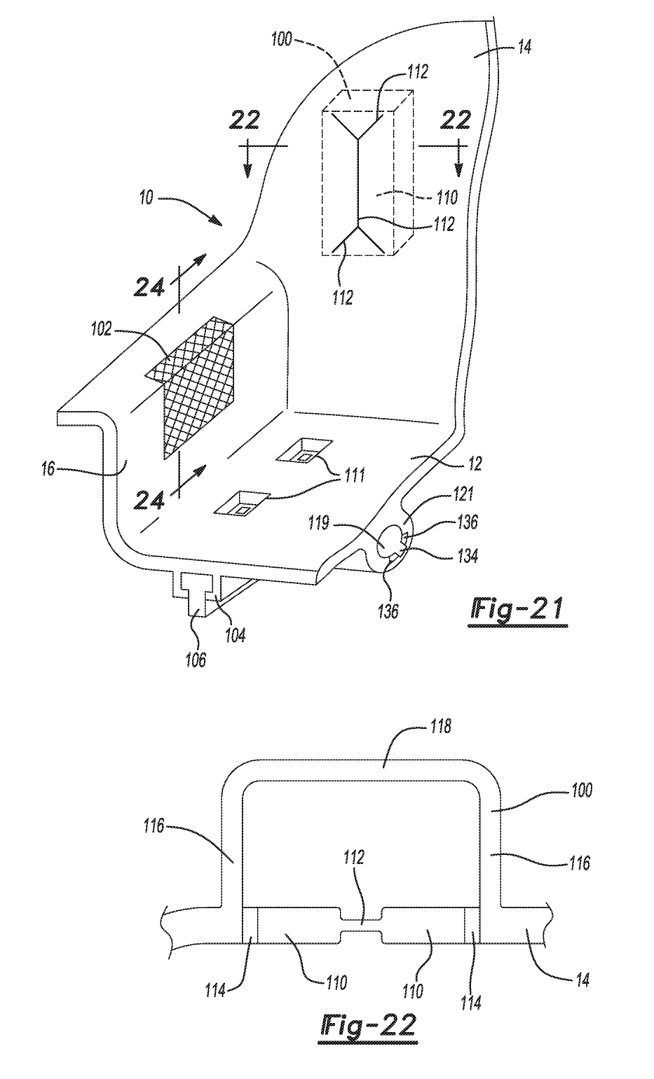

As shown in FIG. 21, the example seat shell 10 includes an airbag housing 100, an energy absorbing portion 102, a rail channel 104, a rail bar 106, a rotational element 119 and trim attachments 111. The airbag housing 100 projects rearward of the seat back 14 and is configured to hold an airbag module 108. The airbag housing 100 includes a deployment door 110 with a tear seam 112 and hinges 114. The airbag housing 100 is configured to permit an airbag cushion located inside the airbag housing to inflate and extend outward through the deployment door 110. When the airbag cushion inflates, the airbag cushion causes the tear seam 112 to tear or otherwise break. This permits the deployment door to rotate outward from the seat back 14. The hinges 114 located along the edges of the deployment door 110 permit this rotation to occur.

As shown in FIG. 22, the deployment door 110 is positioned substantially coplanar with the seat back 14 in the seat shell 10. The tear seam 112 is positioned along a center line of the deployment door 110. The tear seam 112 is a narrow band of material that connects the two halves of the deployment door 110. Similar tear seams 112 can be located along upper and lower portions of the deployment door 110 as well. As shown, the upper and lower tear seams 112 can be oriented at a 45 degree angle to the center tear seam 112.

The hinges 114 are located along the lateral side edges of the deployment door 110. The hinges 114 are formed of a flexible material such as a thermoplastic elastomer. As can be appreciated, when the airbag cushion located inside the airbag housing 100 rapidly inflates, the airbag cushion exerts a force on the inner side of the deployment door 110. This force causes the narrow bands of material at the tear seams 112 to rip or break the deployment door 110 into two halves. The two halves of the deployment door 110 then rotate about the hinges 114 to permit the inflating airbag cushion to project outward from the seat shell 10.

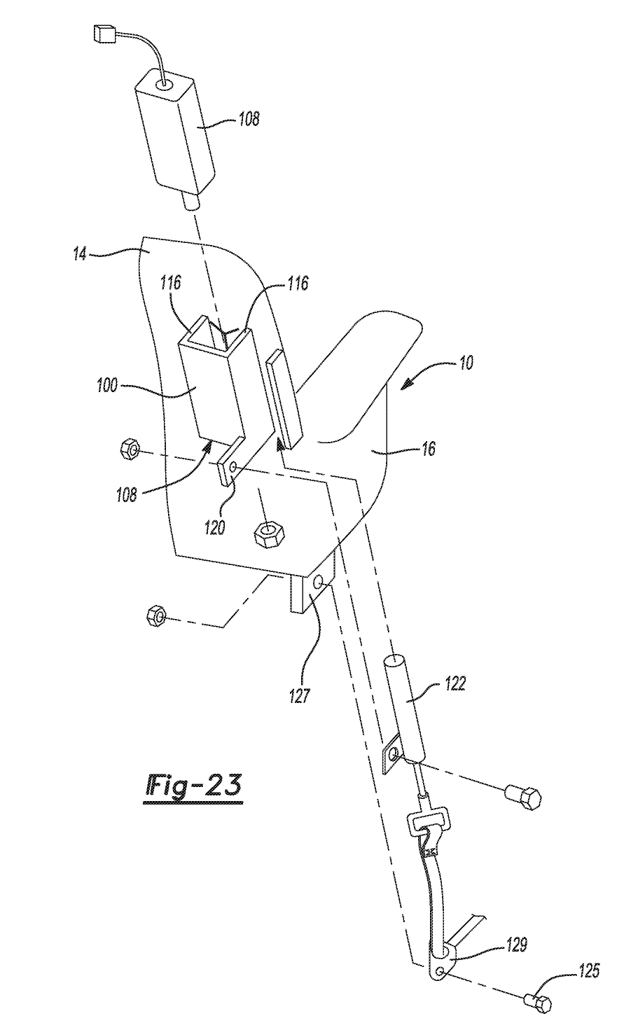

As shown in FIG. 23, the airbag housing includes side walls 116 and a base 118. The airbag module 108 is inserted into the airbag housing 100 and secured in position. The airbag housing 100, in this example, also includes an attachment tab 120. The attachment tab 120 includes a hole. A seat belt pretensioner 122 is connected to the airbag housing 100 at the attachment tab 120 by inserting a bolt or other suitable fastener through the hole in the attachment tab 120 as shown.

A guideloop or seat belt anchor 129 can also be connected to seat shell 10. In the example shown in FIG. 23, the seat shell 10 includes a connection point 127. The seat belt anchor 129 can be connected to the seat shell 10 at connection point 127 by inserting a bolt 125, or other suitable fastener, through the seat belt anchor 129 an into the connection point 127 as shown. In other examples, the connection point 127 can have other shapes and be positioned in alternative locations. The attachment tab 120 and/or the connection point 127 can have a grommet or other reinforcement made of metal or other rigid material inserted into the hole to provide additional strength to the attachment location of the seat belt anchor 129, seat belt pretensioner 122 or other attached elements.

The airbag housing 100, the attachment tab 120 and the connection point 127 are formed into and with the seat shell 10 during the additive manufacturing process. The side walls 116, the base 118, the deployment door 110, the tear seams 112 and the hinges 114 of the airbag housing 100 are all printed during the 3D printing process of forming the seat shell 10. Multiple materials can be used during this process. The hinges 114 are printed of a thermoplastic elastomer to permit the rotation of the deployment door 110. The side walls 116, the base 118 and the deployment door 110 of the airbag housing 100 and the attachment tab 120 and the connection point 127 are printed of a relatively more rigid material, such as an ABS plastic. Other materials can also be used.

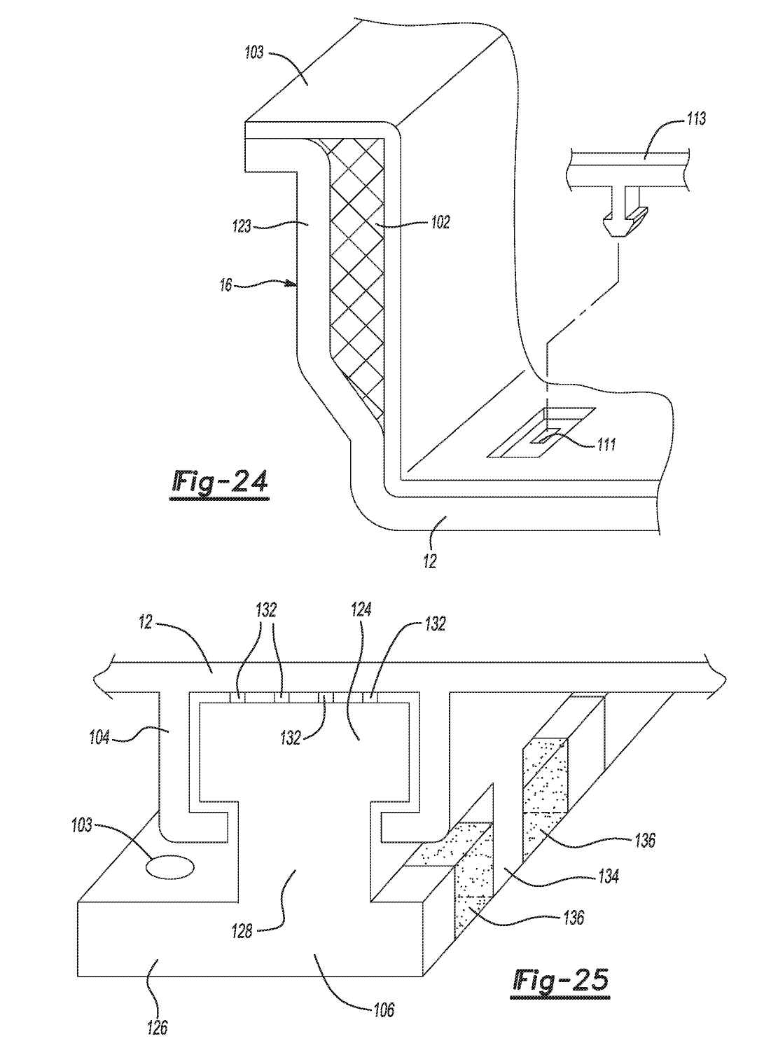

As shown in FIGS. 21 and 24, the energy absorbing portion 102 in the seat shell 10 is located along the first side 16. The seat shell 10, however, can include other energy absorbing portions located in other positions in the seat shell 10. The energy absorbing portion 102, in this example, is located in a central region of the first side 16. In this position, the energy absorbing portion 102 can absorb energy that is exerted in a lateral direction in the seat shell 10.

The energy absorbing portion 102 is a localized region of material that is formed into the seat shell 10 that is relatively more flexible than the surrounding structure of the seat shell 10. The energy absorbing portion 102 is made of a material with a lower density than that of the surrounding portion of the seat shell 10. In this example, the energy absorbing portion is made of a thermoplastic elastomer and the surrounding portions of the first side 16 are made of an ABS plastic. In other examples, other materials are used.

As shown in FIG. 24, the energy absorbing portion 102 extends laterally outward into the first side 16 and is surrounded by a support portion 123. The seat shell 10 can also include a durable show surface 103. The durable show surface 103 can be a layer of material that covers the energy absorbing portion 102 and/or the support portion 123. As explained above, the support portion 123 is made of the relatively rigid material and the energy absorbing portion 102 is made of a flexible material. In this manner, the flexible energy absorbing portion 102 can absorb energy associated with lateral forces transmitted to the seat shell 10. The durable show surface 103 can be printed using a flexible material during the 3D printing process or can be added later by a suitable process. As can be appreciated, the durable show surface 103 can additionally be added in other examples of seat shell 10 to cover other surfaces and other elements previously described.

As shown in FIGS. 21 and 24, the seat shell 10 can include one or more trim attachments 111. The trim attachments 111 can be printed into the seat shell 10 during the 3D printing process. In the example shown, the trim attachments 111 are rectangular-shaped depressions in the seat bottom 12. The trim attachments 111 include apertures centrally located in the depressions that are configured to receive a clip located on a trim component 113. The trim component 113 can be a subassembly or one or more durable show surface materials, foam and suspension material to fit over the seat shell 10. The trim component can be retained relative to the seat shell 10 via a clip or other mechanical attachment. The clip can be a male feature, such an arrow-shaped feature shown in FIG. 24. The clip can be inserted into the aperture in the trim attachment 111 to retain the trim component 113 relative to the seat shell 10. Other configurations and shapes of the trim attachments 111 can also be used and the trim component 113 may include other types of retention features such as clips, U-base fasteners, push pins, push rivets, retention fingers, hooks, barbs or the like. In still another example, the trim attachment 111 can include small wire rods around which a clip can be attached.

As shown in FIGS. 21 and 25, the rail channel 104 and the rail bar 106 are positioned on a bottom surface of the seat bottom 12. The rail channel 104 is a downward facing track that extends along the seat bottom 12. The rail channel 104 has a downward-facing C-shaped cross section and is configured to receive the rail bar 106. The rail bar 106 has rectangular head 124 that is attached to a foot 126 by a narrow neck 128. The rail bar 106 has a shape that fits inside of the rail channel 104 as shown in FIG. 25. The foot 126 of the rail bar 106 includes one or more body attachment holes 130. A bolt or other fastener can be inserted through the body attachment holes 130 to connect the rail bar 106 to the body of the vehicle.

As shown in FIG. 25, the rail bar 106 can include one or more frangible elements 132 connecting the rail bar 106 to the rail channel 104. The frangible elements 132 extend from the inner surface of the rail channel 104 to the outer surface of the head 124 of the rail bar 106. The frangible elements are narrow bands of material that connect the rail bar 106 to the rail channel 104.

The frangible elements 132 are designed to break in order to absorb energy when the seat shell undergoes an acceleration or a deceleration. As can be appreciated, in the absence of the frangible elements 132, the rail bar 106 can slide within the rail channel 104. When present, the frangible elements 132 prevent this relative movement. When the seat shell undergoes an acceleration or a deceleration, one or more of the frangible elements can flex, deform or break in order to absorb the energy associated with the acceleration or deceleration.

In the example shown in FIG. 25, the rail channel 104 also includes an overlapping element such as finger 134 and the rail bar 106 includes a flexible column 136. The finger 134 projects downward from the rail channel 104 along the neck 128 of the rail bar 106 and is connected to or passes between the flexible column 136. The flexible column 136 is a portion of the foot 126 located in front of and behind the overlapping element such as finger 134. The flexible column 136 is made of a flexible material such as a thermoplastic elastomer. The flexible column 136 has the same shape and profile as the foot 126 but is a made of the flexible material.

The interaction of the overlapping element such as finger 134 with the flexible column 136 absorbs energy associated with a deceleration or acceleration of the seat shell 10. During an acceleration or deceleration of the seat shell 10, the finger 134 will exert a force against the flexible column 136. The flexible column 136 can flex or deform in order to absorb energy associated with the acceleration or deceleration. Alternatively, the flexible column 136 may be a deforming member such as deformable metal formation. Such a deforming member can be inserted or attached to the rail bar 106 in such examples. In the example shown, the finger 134 abuts the flexible column. In other examples, the finger 134 and the flexible column 136 can be separated by a gap to allow movement of the seat shell 10 prior to the finger 134 engaging the flexible column 136.

The rail channel 104, the rail bar 106 and the related energy absorbing features such as the frangible elements 132, the finger 134 and the flexible column 136 are formed into the seat shell 10 during the additive manufacturing process. The rail channel 104 and the rail bar 106 are printed as part of seat shell 10. This eliminates the need to subsequently attach these features to the seat shell 10.

Other alternatives to the example rail channel 104 and the rail bar 106 are also contemplated. In one alternative, the rail channel 104 and the rail bar 106 can be reversed in orientation relative to the seat shell 10. In another alternative, the rail channel 104 and/or the rail bar 106 can have curved profiles such that the seat shell 10 moves in an arcuate manner when the rail channel 104 moves relative to the rail bar 106 rather than a linear manner as shown in the example of FIG. 25. As can be appreciated, one or more of the rail channel 104 and the rail bar 106 can be used on the seat shell 10.

Referring back to the FIG. 22, the seat shell 10 can include a rotational element 119 and a rotational element housing 121. The rotational element 119 and the rotational element housing 121 can be used to absorb energy related to a rotation of the seat shell 10. The rotational element 119 and the rotational element housing 121 can be 3D printed in the seat shell 10. The rotational element 119, in this example, is a cylindrical member extending transversely across the bottom of the seat bottom 12. The rotational element 119 includes a finger 134 (or other overlapping element) that extends from the outer surface of the cylindrical portion of the rotational element 119. The finger 134 is positioned inside or between the flexible column 136. As previously discussed, the finger 134 is made of a more rigid material and the flexible column 136 is made of a more flexible material.

In this example, the rotational element 119 is positioned within the rotational element housing 121. The rotational element housing 121 includes a void that is sized to receive the rotational element 119 and to permit the rotation of the rotational element 119 within the void. When the seat shell 10 rotates about a center axis of the rotational element 119, the energy associated with this movement can be absorbed as the finger 134 compresses or stretches the flexible column 136 in the rotational element housing 121.

As can be appreciated, the rotational element 119 can be connected to a seat support structure or the vehicle body such that the seat shell can rotate. In other examples, the rotational element 119 can be stationary with respect to the seat shell 10 and the rotational element housing 121 is secured to or part of the seat support structure of the vehicle body. In other examples, the seat shell 10 can include a rotational element 119 and a rotational element housing 121 that do not include the previously described energy absorbing features. In such examples, the rotational element 119 can be permitted to have unrestricted movement relative to the rotational element housing 121. In still other examples, the finger 134 (or other overlapping element) can be separated from the flexible column 136 to permit movement of the rotational element 119 relative to the rotational element housing 121.

The foregoing described example seat shells 10 include components and features that are integrated into the formed seat shell using additive manufacturing techniques. This integration reduces the packaging space and the mass of the seat shell 10. In addition, the use of additive manufacturing to form the seat shell 10 as previously described reduces the post-fabrication assembly steps necessary to deliver a fully-assembled seat shell.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A seat shell for use in a vehicle comprising:
a support wall including a first surface and a second surface, the first surface configured to support an occupant and the second surface positioned opposite the first surface wherein the first surface and the second surface are separated by a thickness of the support wall; and
a conduit integrally formed in the support wall and positioned between the first and the second surface, the conduit configured to transfer at least one of fluid, electricity and force from a first location in the support wall to a second location in the support wall.

2. The seat shell of claim 1 wherein the support wall is a seat bottom and the conduit is a plurality of channels that are configured to draw air into the plurality of channels and transfer the air to a climate control system of the vehicle.

3. The seat shell of claim 2 further comprising a vent located on the first surface of the support wall, the vent including one or more openings to permit air to flow into the plurality of channels.

4. The seat shell of claim 1 wherein the conduit is a first wire embedded in the support wall between the first surface and the second surface, the first wire configured to transmit a signal to or from at least one of a control module and a sensor.

5. The seat shell of claim 4 further comprising a second wire embedded in the support wall between the first surface and the second surface, the second wire positioned in the support wall such that the second wire crosses the first wire in the support wall and the second wire is insulated from the first wire.

6. The seat shell of claim 1 further comprising an inflatable bladder in the support wall, the inflatable bladder including an inlet port connected to an air source and a flexible membrane wall, the flexible membrane wall adapted to move in response to a change in air pressure inside the inflatable bladder.

7. The seat shell of claim 6 wherein the flexible membrane wall of the inflatable bladder is integrally formed in the support wall.

8. The seat shell of claim 6 wherein the inflatable bladder is fluidly connected to the conduit at the inlet port and the conduit is a pressure line that is configured to transfer air from the air source to the inflatable bladder.

9. The seat shell of claim 1 further comprising a lever connected to the second surface of the support wall and to an adjustment mechanism, the adjustment mechanism configured to adjust a position of the seat shell in the vehicle, wherein:
the conduit is a pathway within the support wall that is configured to receive a cable therethrough; and
the cable is connected to the lever and to the adjustment mechanism such that a force applied to the lever is transferred by the cable through the conduit to the adjustment mechanism.

10. The seat shell of claim 1 further comprising a second support wall including a reinforcement embedded in the second support wall configured to stiffen the second support wall.

11. The seat shell of claim 10 wherein:
the second support wall defines a reinforcement cavity located within the second support wall, the reinforcement cavity configured to receive a first portion of the reinforcement therein; and
the reinforcement is secured in position by forming the second support wall around a second portion of the reinforcement after the first portion of the reinforcement is positioned in the reinforcement cavity.

12. The seat shell of claim 1 further comprising a seat connector located on the support wall configured to connect the seat shell to the vehicle, the seat connector including a fastener embedded in the support wall and projecting away from the second surface and a flexible bumper integrally attached to the second surface, wherein the seat connector is configured to dampen vibrations of the seat shell.

13. The seat shell of claim 1 further comprising an airbag housing integrally formed with and connected to the support wall, the airbag housing including a deployment door with a tear seam, wherein:
the airbag housing is configured to receive an airbag module with a deployable airbag cushion; and
the tear seam of the deployment door is configured to break when the deployment door moves from a closed position to an open position to permit deployment of the airbag cushion.

14. The seat shell of claim 13 wherein the airbag housing includes an integrally formed attachment point for connecting a seat belt pretensioner to the seat shell.

15. The seat shell of claim 1 wherein the support wall includes an energy absorbing portion made of a first material with a first density and a rigid portion made of a second material with a second density, the first density being less than the second density.

16. The seat shell of claim 1 further comprising:
a rail channel integrally formed with and attached to the support wall;
a rail bar integrally formed with and positioned inside the rail channel, wherein:
the rail bar is connected to the rail channel by a plurality of frangible elements; and
the plurality of frangible elements are configured to break to absorb energy when the seat shell is decelerated.

17. The seat shell of claim 1 further comprising:
a rail channel integrally formed with and attached to the support wall, the rail channel including a finger projecting away from the rail channel;
a rail bar integrally formed with and positioned inside the rail channel, the rail bar including a flexible column; and
wherein the finger is connected to the flexible column of the rail bar such that the flexible column flexes to absorb energy in response to a deceleration of the seat shell.

18. The seat shell of claim 1 formed by a 3D printing process wherein the conduit is integrally formed into the seat shell during the printing process.

19. The seat shell of claim 1 further comprising:
a rotational element housing integrally formed with and attached to the support wall; the rotational element including a flexible column;
a rotational element integrally formed with and positioned inside the rotational element housing, the rotational element including a finger; and
wherein the finger is connected to the flexible column such that the flexible column flexes to absorb energy in response to a rotational movement of the seat shell.

20. The seat shell of claim 1 further comprising one or more trim attachments integrally formed with and positioned in the support wall, the trim attachments configured to receive a mating trim component and secure the mating trim component relative to the support wall.
